(19) United States
(12) Patent Application Publication
(10) Pub. No.: US 2014/0327708 A1
(43) Pub. Date: Nov. 6, 2014

(54) DISPLAY DEVICE

(71) Applicant: Sharp Kabushiki Kaisha, Osaka (JP)

(72) Inventor: Ryo Yamakawa, Osaka (JP)

(73) Assignee: SHARP KABUSHIKI KAISHA, Osaka (JP)

(21) Appl. No.: 14/357,708

(22) PCT Filed: Nov. 7, 2012
(86) PCT No.: PCT/JP2012/078814

§ 371 Date: May 12, 2014

(30) Foreign Application Priority Data
Nov. 15, 2011 (JP) 2011-249643

(51) Int. Cl. G09G 3/36; F21V 8/00

(52) U.S. Cl. CPC G09G 3/36; G02B 6/0011; G09G 2310/0243; G09G 2320/0233
USPC 345/690; 345/102

(57) ABSTRACT

Provided is a liquid crystal display device (display device) 1 equipped with a backlight device (backlight unit) 3 and a liquid crystal panel (display unit) 2. In the liquid crystal display device 1, the backlight device 3 is provided with a light guide plate 6 that, while guiding the light from a light emitting diode (light source) 4 in a predetermined direction, emits light to the liquid crystal panel 2 side. In the backlight device 3, by means of altering the light output rate of each section of the light emitting surface 6b of the light guide plate 6, the luminance distribution of the illumination light to the liquid crystal panel 2 is adjusted in accordance with the luminance distribution of the liquid crystal panel 2 alone in a manner such that the luminance distribution of light outputted from the liquid crystal panel 2 becomes substantially even.

### TECHNICAL FIELD

The present invention relates to a display device, and in particular, relates to a non-light-emitting display device such as a liquid crystal display device.

### BACKGROUND ART

In recent years, liquid crystal display devices, for example, are widely used in liquid crystal televisions, monitors, mobile phones, and the like as a flat panel display having advantages compared to conventional cathode-ray tubes in being thinner, lighter, and the like. Such liquid crystal display devices include a backlight device that emits light and a liquid crystal panel that displays desired images by acting as a shutter for light from light sources provided in the backlight device.

Also, in such liquid crystal display devices, typically, gradation correction (gamma correction) according to a prescribed gamma curve is performed based on luminance information (gradation value) for each pixel included in the image signal that comes from outside.

Also, in conventional liquid crystal display devices, as disclosed in Patent Document 1 below, for example, using a plurality of gamma curves according to a combination of the luminance of a backlight device and the luminance of the surrounding environment where the liquid crystal panel is placed is proposed. In such conventional liquid crystal display devices, even if the luminance of the backlight device is changed on the basis of luminance information for each pixel included in the image signal that comes from outside, it is possible to improve the visibility in low gradation areas.

### RELATED ART DOCUMENT

### Patent Document

Patent Document 1: Japanese Patent Application Laid-Open Publication No. 2011-53264

### SUMMARY OF THE INVENTION

### Problems to be Solved by the Invention

However, in the conventional liquid crystal display device described above, there was a risk that display quality could not be improved. In particular, in the conventional liquid crystal display device, there was a problem that it was difficult to improve display quality when the liquid crystal panel (display quality, display unit) was made large.

Here, the problems of the conventional liquid crystal display device will be described in detail with reference to FIGS. 18 to 20.

FIG. 18 is a view showing main components of the conventional liquid crystal display device. FIGS. 19(a) to 19(h) are timing charts showing an operation example in the respective parts of the liquid crystal panel shown in FIG. 18. FIGS. 20(a) and 20(b) are graphs showing examples of target gamma curves and measurement results in a central portion BC and edge portions BE respectively shown in FIG. 18.

In FIG. 18, a widely adopted technique is used in which a liquid crystal panel LP included in the conventional liquid crystal display device has an active matrix substrate, and on the active matrix substrate, a plurality of data lines (source lines) and a plurality of scan lines (gate lines) are arranged in a matrix (not shown). Also, the plurality of source lines are connected to a plurality of source drivers 51 (eight, for example) such that the source lines are evenly distributed among the source drivers 51. The plurality of gate lines are connected to a plurality of gate drivers 52a and 52b (four, for example) provided in the left and right sides of the liquid crystal panel LP such that the gate lines are evenly distributed among the gate drivers. In other words, in the liquid crystal panel LP, the left ends and right ends of the respective gate lines are connected to the left side and right side gate drivers 52a and 52b.

In the liquid crystal panel LP, a plurality of pixels are respectively provided at the intersections between the source lines and gate lines. Also, the source drivers 51 supply to the corresponding source lines gradation voltages as gradation signals after gradation correction using a prescribed gamma curve is performed on luminance information (gradation value) for each pixel included in the image signal supplied from outside. In the liquid crystal panel LP, by supplying scan signals to both the left end and right end of the gate lines from the gate drivers 52a and 52b, the liquid crystal layer (not shown) is charged per pixel with the gradation voltage. As a result, in the liquid crystal panel LP, the transmittance per pixel is controlled, thus displaying a desired image.

However, in the conventional liquid crystal display device, due to wiring resistance in the gate lines, compared to pixels in the edges BE of the liquid crystal panel LP, the charging of the gradation voltage in the pixels in the central portion BC of the liquid crystal panel LP was insufficient. Thus, in the conventional liquid crystal display device, when displaying images, there were cases in which an image was not displayed with the desired luminance throughout the entire display screen.

Specifically, if the gate clock GLK turns ON at time T1 as shown in FIG. 19(a) in a given pixel P included in the edge portion BE of the liquid crystal panel LP, a scan signal Gout ge is supplied to the gate line corresponding to the gate drivers 52a and 52b. Next, when the control signal LS to the source drivers 51 turns ON at time T2, a gradation signal (gradation voltage) Sout se is supplied from the source driver 51 to the corresponding source line. In other words, in the pixel P, charging of the gradation voltage starts at time T2.

Then, when the gate clock GLK turns ON at time T3, the scan signal Gout ge to the corresponding gate line is stopped. Next, when the control signal LS to the source driver 51 turns ON at time T4, the gradation signal Sout se to the corresponding source line is stopped. In the pixel P, the charging of the gradation voltage is stopped at time T3. In other words, in the pixel P, the period between the time T2 and the time T3 is the charging period for the gradation voltage.

On the other hand, if the gate clock GLK turns ON at time T1 in a given pixel P′ included in the central portion BC of the liquid crystal panel LP as shown in FIG. 19(e), then a scan signal Gout gc is supplied to the gate line corresponding to the gate drivers 52a and 52b. However, the pixel P′ is far from the gate drivers 52a and 52b, and thus, the scan signal Gout gc does not reach a prescribed value by time T5 due to the resistance in the gate line. As a result, even if the control signal LS to the source driver 51 turns on at time T2 and the gradation signal Sout sc (gradation voltage) is supplied to the corresponding source line from the source driver 51, in the pixel P′, the charging of the gradation voltage is insufficient during the period between the time T2 and the time T5, and starts at time T5.

Then, when the gate clock GLK turns ON at time T3, the scan signal Gout gc to the corresponding gate line is stopped. Next, when the control signal LS to the source driver 51 turns ON at time T4, the gradation signal Sout sc to the corresponding source line is stopped. In the pixel P′, the charging of the gradation voltage is stopped at time T3. In other words, in the pixel P′, the period between the time T5 and the time T3 is the charging period for the gradation voltage, and this period is shorter compared to the charging period for the pixel P.

As a result, as shown in FIGS. 20(a) and 20(b), the relation between the gradation values (at a gradation of 8 bits=256, for example) and the luminance of outputted light is not the same in the central portion BC and the edge portions BE of the liquid crystal panel LP, which prevented improvements in display quality.

Specifically, in the central portion BC of the liquid crystal panel LP, as shown in FIG. 20(a), the curve 60 depicted with a solid line and representing the measurement result substantially matches the target gamma curve 61 depicted with a dotted line.

By contrast, in the edge portions BE of the liquid crystal panel LP, as shown in FIG. 20(b), the curve 62 depicted with a solid line and representing the measurement result greatly deviates from the target gamma curve 61 depicted with a dotted line.

In other words, in the conventional liquid crystal display device, in the liquid crystal panel LP, charging is insufficient in the central portion BC due to resistance in the gate line as compared to the edge portions BE, and there is a tendency for the luminance of the outputted light to be lower in the central portion BC than in the edge portions BE.

As described above, the relation between the gradation value and the luminance of the outputted light is not the same between the central portion BC and the edge portions BE of the liquid crystal panel LP, and thus, uneven luminance in light outputted to the outside from the liquid crystal panel could not be prevented. As a result, in the conventional liquid crystal display device, it was sometimes not possible to improve display quality. In particular, when using a large liquid crystal panel for the conventional liquid crystal display device, it was difficult to improve display quality. The reason that the gamma curve 61 and the curve 60 substantially match in the central portion BC, is because the gradation voltage is set to be large, taking into consideration the resistance in the gate lines (shortening of the charging period of the gradation voltage).

The present invention takes into account these problems, and an object thereof is to provide a display device with which it is possible to improve display quality even with a large display unit.

### Means for Solving the Problems

In order to attain the above-mentioned object, a display device according to the present invention includes:

a backlight unit having a light source;

a display unit that includes a plurality of pixels and that displays information using illumination light from the backlight unit; and

a controller that performs drive control of at least the display unit using an inputted image signal,

wherein, in the backlight unit, adjustment of a luminance distribution of illumination light to the display unit is performed in response to a luminance distribution of only the display unit such that a luminance distribution of light outputted from the display unit is substantially even.

In the display device configured as described above, in the backlight unit, the luminance distribution of illumination light to the display unit is adjusted in response to the luminance distribution in the display unit alone such that the luminance distribution of light outputted from the display unit is substantially even. As a result, unlike the conventional example, even if the display unit is made large, it is possible to prevent the occurrence of uneven luminance in the light outputted from the display unit, and thus, it is possible to improve display quality.

Luminance distribution of the display unit alone means the luminance distribution of light outputted from the display unit when an illumination light of even luminance distribution is radiated on the display unit that displays information at a prescribed gradation value.

Also, in the above-mentioned display device, the backlight unit may be provided with a light guide plate that guides light from the light source in a prescribed direction so as to output the light towards the display unit, and

in the backlight unit, adjustment of the luminance distribution of the illumination light to the display unit may be performed in response to a luminance distribution of only the display unit such that a luminance distribution of light outputted from the display unit is substantially even by changing rates of light output in respective portions of a light-emitting surface of the light guide plate.

In this case, by changing the light-emitting rate in respective portions of the light-emitting surface of the light guide plate, even if the display unit is made large, it is possible to have a display device in which it is possible to improve display quality.

Also, in the above-mentioned display device, the backlight unit may be provided with a reflective unit that reflects light from the light source back towards the display unit, and

in the backlight unit, adjustment of the luminance distribution of the illumination light to the display unit may be performed in response to a luminance distribution of only the display unit such that a luminance distribution of light outputted from the display unit is substantially even by changing reflectance in respective portions of the reflective unit.

In this case, by changing the reflectance in respective portions of the reflective unit, even if the display unit is made large, it is possible to have a display device in which it is possible to improve display quality.

Also, in the above-mentioned display device, the backlight unit may be provided with a prism sheet that collects illumination light traveling to the display unit, and in the backlight unit, adjustment of the luminance distribution of the illumination light to the display unit may be performed in response to a luminance distribution of only the display unit such that a luminance distribution of light outputted from the display unit is substantially even by changing a rate of light collection in respective portions of the prism sheet.

In this case, by changing the rate of light collection in respective portions of the prism sheet, even if the display unit is made large, it is possible to have a display device in which it is possible to improve display quality.

Also, in the above-mentioned display device, the display unit may be provided with a plurality of display areas,

the backlight unit may have a plurality of light-emitting areas that radiate light from the light source to the plurality of display areas, respectively,

the controller may be configured so as to perform drive control of the display unit and the backlight unit based on an inputted image signal, and

in the backlight unit, adjustment of the luminance distribution of the illumination light to the display unit may be performed in response to a luminance distribution of only the display unit such that a luminance distribution of light outputted from the display unit is substantially even by changing a luminance of light from the plurality of light-emitting areas.

In this case, by changing the luminance of light from the respective plurality of light-emitting areas, even if the display unit is made large, it is possible to have a display device in which it is possible to improve display quality.

Also, in the above-mentioned display device, in the backlight unit, it is preferable that the luminances of the light from the plurality of light-emitting areas be changed based on gradation values in the display unit.

In this case, the luminance of light from the light-emitting areas is changed on the basis of the gradation value, and thus, even if the display unit is made large, it is possible to have a display device in which it is possible to improve display quality.

In the above-mentioned display device, the display unit may be a liquid crystal panel.

In this case, it is possible to configure a liquid crystal display device of excellent display quality with ease.

### Effects of the Invention

According to the present invention, even if the display unit is made large, it is possible to provide a display device with which the display quality can be improved.

### BRIEF DESCRIPTION OF THE DRAWINGS

FIG. 1 is a view showing a liquid crystal display device according to Embodiment 1 of the present invention.

FIG. 2 is a view showing the configuration of main components the liquid crystal panel shown in FIG. 1.

FIG. 3 is a block diagram showing a configuration example of a panel controller shown in FIG. 2.

FIG. 4 is a block diagram showing a configuration example of a backlight controller shown in FIG. 2.

FIG. 5 shows a specific configuration example of source drivers and gate drivers included in the liquid crystal panel.

FIGS. 6(a), 6(b), and 6(c) respectively show a luminance distribution of the liquid crystal panel alone, a luminance distribution of a light guide plate shown in FIG. 2 alone, and a luminance distribution of the entire liquid crystal display device.

FIGS. 7(a), 7(b), and 7(c) respectively show a luminance distribution of the liquid crystal panel alone, a luminance distribution of a reflective sheet alone, and a luminance distribution of the entire liquid crystal display device, in a liquid crystal display device of Embodiment 2.

FIGS. 8(a), 8(b), and 8(c) respectively show a luminance distribution of the liquid crystal panel alone, a luminance distribution of a prism sheet alone, and a luminance distribution of the entire liquid crystal display device, in a liquid crystal display device of Embodiment 3.

FIG. 9 is a view showing a liquid crystal display device according to Embodiment 4 of the present invention.

FIG. 10 is a view showing the configuration of main components the backlight device shown in FIG. 9.

FIG. 11 shows a specific example of a plurality of light-emitting areas provided in the backlight device shown in FIG. 9 and a plurality of display areas that receive light from the light-emitting areas.

FIG. 12 is a view showing the configuration of main components the liquid crystal panel shown in FIG. 9.

FIG. 13 is a block diagram showing a configuration example of a panel controller shown in FIG. 12.

FIG. 14 is a block diagram showing a configuration example of a backlight controller shown in FIG. 12.

FIGS. 15(a), 15(b), and 15(c) respectively show a luminance distribution of the liquid crystal panel alone, a luminance distribution of a backlight device alone, and a luminance distribution of the entire liquid crystal display device, in a liquid crystal display device of Embodiment 3.

FIG. 16 is a block diagram showing a configuration example of a backlight controller in a liquid crystal display device of Embodiment 5.

FIGS. 17(a), 17(b), and 17(c) respectively show a luminance distribution of the liquid crystal panel alone, a luminance distribution of a backlight device alone, and a luminance distribution of the entire liquid crystal display device, in a liquid crystal display device of Embodiment 5.

FIG. 18 is a view showing main components of a conventional liquid crystal display device.

FIGS. 19(a) to 19(h) are timing charts showing an operation example in the respective parts of the liquid crystal panel shown in FIG. 18.

FIGS. 20(a) and 20(b) are graphs showing examples of target gamma curves and measurement results in a central portion BC and edge portions BE respectively shown in FIG. 18.

### DETAILED DESCRIPTION OF EMBODIMENTS

Below, preferred embodiments of a display device of the present invention will be described with reference to figures. In the descriptions below, the application of the present invention in a transmissive liquid crystal display device will be explained as an example. The dimensions of constituting members in respective figures do not faithfully represent the dimensions of actual constituting members, dimensional ratios of the respective constituting members, or the like.

### Embodiment 1

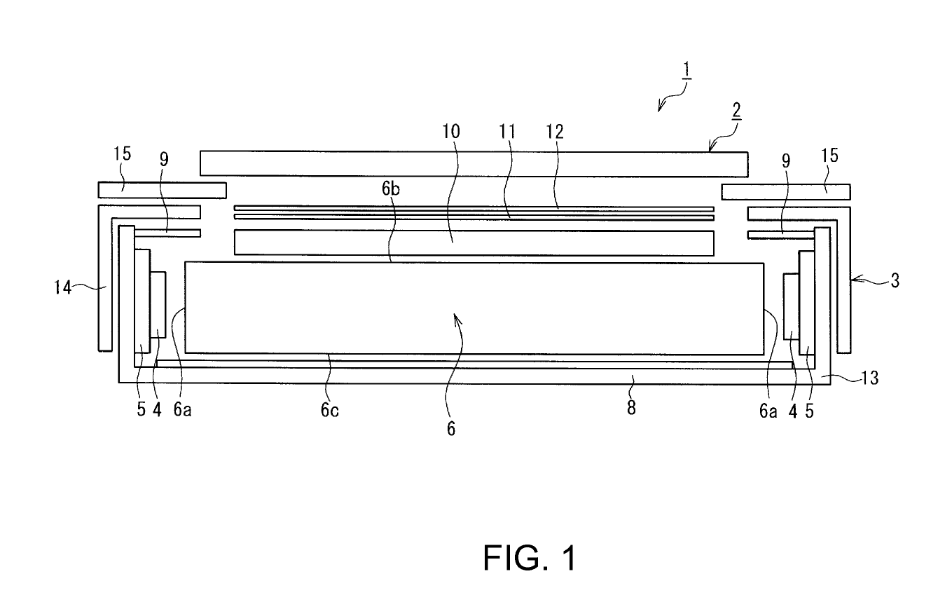

FIG. 1 is a view showing a liquid crystal display device according to Embodiment 1 of the present invention. In FIG. 1, the liquid crystal display device 1 of the present embodiment is provided with a liquid crystal panel 2 as a display unit that displays information, and a backlight device 3 as a backlight unit. The liquid crystal display device 1 is configured so as to display information by the liquid crystal panel 2 being illuminated by light from the backlight device 3, and the liquid crystal panel 2 and the backlight device 3 integrally constitute a transmissive liquid crystal display device 1.

The liquid crystal panel 2 includes a liquid crystal layer, and an active matrix substrate and color filter substrate forming a pair of substrates that sandwich this liquid crystal layer (not shown). On the active matrix substrate, as described later, pixel electrodes, thin film transistors (TFTs), and the like are formed between the active matrix substrate and the liquid crystal layer for the respective plurality of pixels included in the display surface of the liquid crystal panel 2. On the other hand, on the color filter substrate, color filters, a common electrode, and the like are formed between the color filter substrate and the liquid crystal layer (not shown).

Also, in the liquid crystal panel 2, a control device (not shown) that performs drive control in the liquid crystal panel 2 is provided, and by operating the liquid crystal layer for each pixel unit, the display surface is driven on the pixel level, thus display a desired image on the display surface.

For the liquid crystal panel 2 of the present embodiment, a normally black mode type is used, for example. In other words, the liquid crystal panel 2 of the present embodiment is configured such that the display is black when no voltage is applied to the liquid crystal layer, and the transmittance in the liquid crystal layer increases in response to an applied voltage.

Also, the backlight device 3 is provided with light-emitting diodes 4 as light sources, LED substrate 5 as light source substrates upon which the light-emitting diodes 4 are installed, and a light guide plate 6 that guides light from the light-emitting diodes 4 in a prescribed propagation direction (left-and-right direction in FIG. 1) and radiates this light to the liquid crystal panel 2 (object to be illuminated). The light guide plate 6 is made of a synthetic resin such as a transparent acrylic resin having a rectangular cross-sectional shape, for example, and this light guide plate 6 includes light-receiving faces 6a that are disposed facing the light-emitting diodes 4 and that receive light from the light-emitting diodes 4, a light-emitting surface 6b that emits light towards the liquid crystal panel 2, and an opposite surface 6c that is opposite to the light-emitting surface 6b.

In the light guide plate 6, by changing the rate of light output in various portions of the light-emitting surface 6b, the luminance distribution of the illumination light to the liquid crystal panel 2 is adjusted based on the luminance distribution of the liquid crystal panel 2 alone such that the luminance distribution of light outputted from the liquid crystal panel 2 (display unit) is made substantially even (details to be described later).

The backlight device 3 includes a reflective plate 8 as a reflective unit that is disposed below the light-emitting diodes 4 and the light guide plate 6 and that reflects light from the light-emitting diodes 4 and the light guide plate 6, and reflective plates 9 that are provided between the light-emitting diodes 4 and the liquid crystal panel 2 and that reflect light from the light-emitting diodes 4. Also, the backlight device 3 has a diffusion sheet 10, a prism sheet 11, and a reflective polarizing sheet 12, for example, in that order from the light guide plate 6 as optical members provided between the light guide plate 6 and the liquid crystal panel 2, the optical members converting light from the light-emitting surface 6b of the light guide plate 6 into planar illumination light and outputting this light to the liquid crystal panel 2.

Furthermore, the backlight device 3 is provided with: a chassis 13 having a bottom that houses the light-emitting diodes 4, the light guide plate 6, the diffusion sheet 10, the prism sheet 11, and the reflective polarizing sheet 12; and a bezel 14 that is a frame having an opening and an L-shaped cross-section, the bezel being attached to the chassis 13 and constituting the outer casing of the backlight device 3. In the liquid crystal display device 1 of the present embodiment, a P (plastic) chassis 15 is disposed on the bezel 14, and the liquid crystal panel 2 is mounted on the P chassis 15, and thus, the liquid crystal panel 2 and the backlight device 3 are attached to each other.

Besides what was described, a configuration may be adopted in which, instead of providing the reflective plate 8, a coating material having a color with a high reflectance such as silver or white is coated onto the bottom surface of the chassis 13 facing the light-emitting diodes 4 and the light guide plate 6, thereby providing a reflective portion that reflects light from the light-emitting diodes 4 and light from the light guide plate 6.

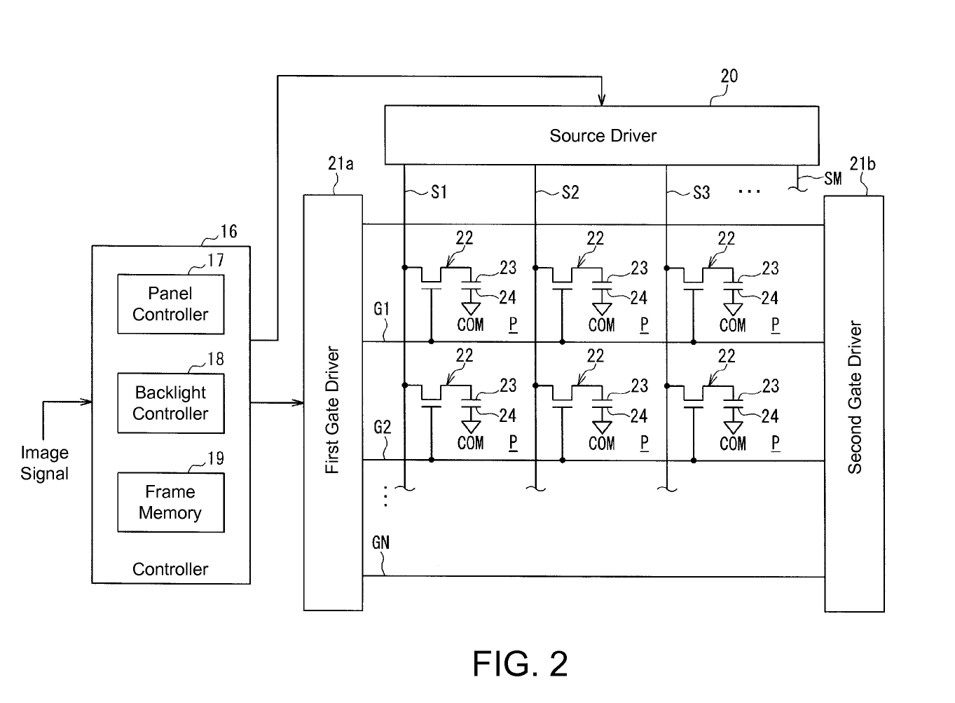

Next, the liquid crystal panel 2 of the present embodiment will be described in detail with reference to FIGS. 2 to 5.

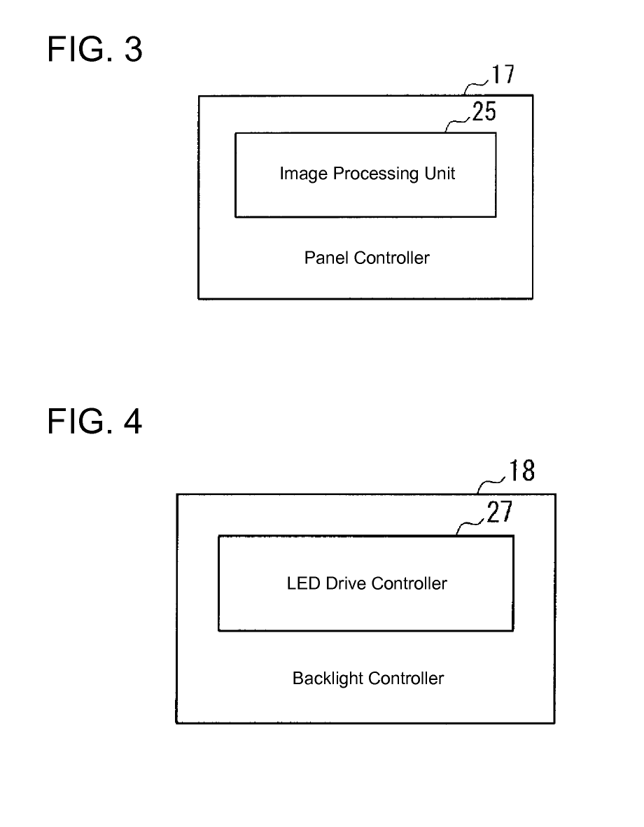

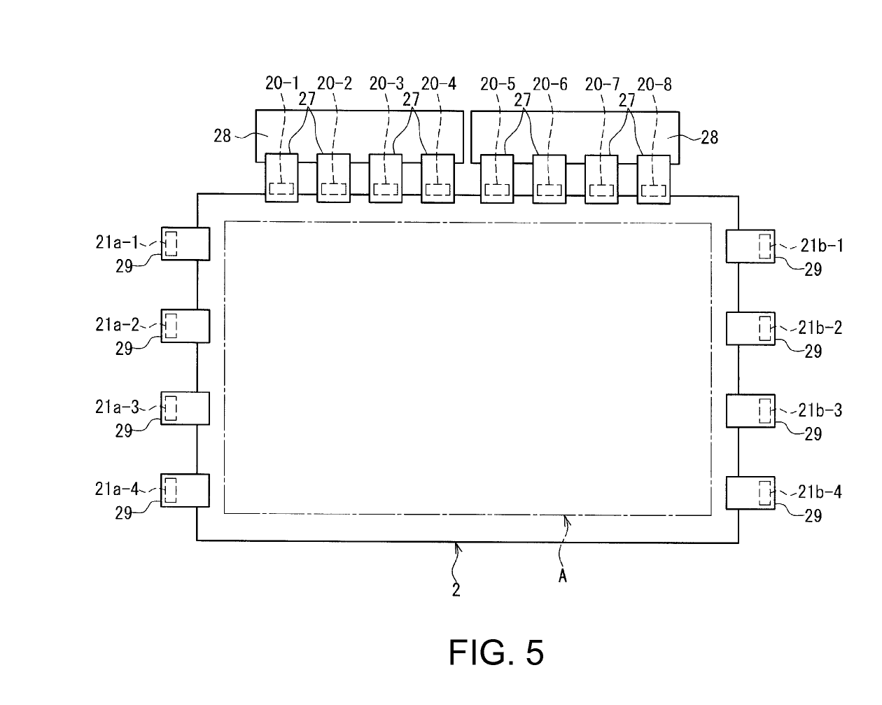

FIG. 2 is a view showing the configuration of main components of the liquid crystal panel shown in FIG. 1. FIG. 3 is a block diagram showing a configuration example of a panel controller shown in FIG. 2. FIG. 4 is a block diagram showing a configuration example of a backlight controller shown in FIG. 2. FIG. 5 shows a specific configuration example of source drivers and gate drivers provided in the liquid crystal panel.

In FIG. 2, the controller 16 receives image signals from outside the liquid crystal display device 1 through a signal source (not shown) such as a TV (receiver) or a personal computer. This controller 16 is configured so as to actually perform drive control on the liquid crystal panel 2 using the inputted image signals. Furthermore, the controller 16 also actually performs drive control on the backlight device 3 using the inputted image signal.

Specifically, the controller 16 is provided with the panel controller 17 that performs drive control on the liquid crystal panel 2 on the pixel level using the image signal, the backlight controller 18 that performs drive control on the respective light-emitting diodes 4 of the backlight device 3 using the image signal, and a frame memory 19 configured so as to be able to store display data per frame unit included in the image signal. The panel controller 17 and the backlight controller 18 are each made of an ASIC (application specific integrated circuit), for example, and the panel controller 17 and the backlight controller 18 can perform prescribed calculations at a high speed on the display data consecutively stored in the frame memory 19. As described above, the panel controller 17 and the backlight controller 18 are provided, and thus, in the liquid crystal display device 1 of the present embodiment, the panel controller 17 and the backlight controller 18 can respectively drive the liquid crystal panel 2 (display unit) and the backlight device 3 (backlight unit) appropriately, and thus, a high quality display can be attained with ease. In other words, in the liquid crystal display device 1 of the present embodiment, the luminance of illumination light is decreased in light-emitting areas corresponding to dark portions of the image in the display surface of the liquid crystal panel 2, and the luminance of illumination light is increased in light-emitting areas corresponding to bright portions of the image, thereby improving dynamic contrast.

Besides what was described above, the backlight controller 18 may be configured so as to perform drive control on the light-emitting diodes 4 using an external light-adjustment command signal, for example, without using the inputted image signal.

Also, as shown in FIG. 2, in the liquid crystal panel 2 of the present embodiment, the first and second gate drivers 21a and 21b are respectively provided on the left edge and the right edge of the liquid crystal panel 2. These gate drivers 21a and 21b are respectively connected to the left ends and right ends of gate lines G described below.

In FIG. 2, the source driver 20 and the first and second gate drivers 21a and 21b are driver circuits that drive a plurality of pixels P provided in the liquid crystal panel 2 on the pixel level, and a plurality of source lines S1 to SM (M being an integer of two or greater; hereinafter collectively referred to as “S”), and a plurality of gate lines G1 to GN (N being an integer of two or greater; hereinafter collectively referred to as “G”) are respectively connected to the source driver 20 and the first and second gate drivers 21a and 21b. The source lines S1 to SM and the gate lines G1 to GN are arranged in a matrix, and the respective regions delineated by the matrix are regions where the plurality of pixels P are formed. Among the plurality of pixels P are red, green, and blue pixels P. The red, green, and blue pixels P are arranged, in this order, for example, in parallel with the gate lines G1 to GN.

As shown in FIG. 3, the panel controller 17 is provided with an image processing unit 25 that generates various command signals to the source driver 20 and the first and second gate drivers 21a and 21b shown in FIG. 2, on the basis of the image signals. The image processing unit 25 is configured so as to perform prescribed image processing including gradation correction on the image signal, and to output command signals based on the result of image processing to the source driver 20 and the first and second gate drivers 21a and 21b.

As shown in FIG. 4, the backlight controller 18 is provided with an LED drive controller 27 that performs actual drive control on the respective light-emitting diodes 4 using the image signals. In other words, the LED drive controller 27 uses the image signals to generate command signals to the respective light-emitting diodes 4, thus controlling illumination driving of the respective light-emitting diodes 4.

A plurality of source drivers 20 and a plurality of first and second gate drivers 21a and 21b are provided so as to be aligned along the horizontal direction and the vertical direction of the liquid crystal panel 2. Also, the plurality of source drivers 20 and the plurality of gate drivers 21 are disposed for the respective plurality of display areas of the display surface of the liquid crystal panel 2, and appropriately drive the pixels P included in the respectively corresponding display areas.

Specifically, as shown in FIG. 5, a plurality (eight, for example) of source drivers 20-1 to 20-8 (hereinafter collectively referred to as “20”) are respectively mounted on the eight flexible printed circuit boards 27 (SOF). One end of each of the flexible printed circuit boards 27 is connected to each of the source lines S on the active matrix substrate outside an active display region A. The source drivers 20-1 to 20-8 have connected thereto the same number of source lines S each; that is, they are connected to M/8 source lines S.

The other end of the flexible printed circuit boards 27 is connected to either one of two printed circuit boards 28. In the liquid crystal panel 2, command signals based on information displayed in the display unit of the liquid crystal panel 2 are inputted from the panel controller 17 to the respective source drivers 20-1 to 20-8. Then, the source drivers 20-1 to 20-8 output a gradation signal to the respective corresponding source lines S.

On the left edge and right edge of the liquid crystal panel 2, a plurality (four, for example) of gate drivers 21a-1 to 21a-4 (hereinafter collectively referred to as “21a”) and four gate drivers 21b-1 to 21b-4 (hereinafter collectively referred to as “21b”) are respectively provided. The gate drivers 21a-1 to 21a-4 and the gate drivers 21b-1 to 21b-4 are respectively mounted on the flexible printed circuit boards 29 (SOF). One end of each of the flexible printed circuit boards 29 is connected to each of the gate lines G on the active matrix substrate outside an active display region A. Also, the left end and right end of the respective gate lines G are connected to the left edge and right edge gate drivers 21a and 21b. Each of the gate drivers 21a-1 to 21a-4 and the gate drivers 21b-1 to 21b-4 have connected thereto the same number of gate lines G each; that is, they are each connected to N/4 gate lines G.

Furthermore, the respective gate drivers 21a-1 to 21a-4 and the respective gate drivers 21b-1 to 21b-4 are connected to the panel controller 17 through corresponding flexible printed circuit boards 29 and wiring lines (not shown) provided on the active matrix substrate. The respective gate drivers 21a-1 to 21a-4 and the respective gate drivers 21b-1 to 21b-4 receive command signals from the panel controller 17 and output scan signals to be described later to the corresponding gate lines G.

Returning to FIG. 2, the respective gate lines G1 to GN have connected thereto gates of the switching elements 22 provided for the respective pixels P. On the other hand, the respective source lines S1 to SM have connected thereto sources of the switching elements 22. Pixel electrodes 23 provided for the respective pixels P are connected to the drains of the switching elements 22. A common electrode 24 faces the pixel electrode 23 in each pixel P while the liquid crystal layer provided in the liquid crystal panel 2 is sandwiched therebetween. The first and second gate drivers 21a and 21b sequentially output a gate signal (scan signal) to turn ON the gates of the corresponding switching elements 22 for each of the gate lines G1 to GN on the basis of command signals from the image processing unit 25. On the other hand, the source drivers 20 output to the source lines S1 to SM gradation signals (gradation voltages) based on the luminance (gradation) of the display image on the basis of command signals from the image processing unit 25.

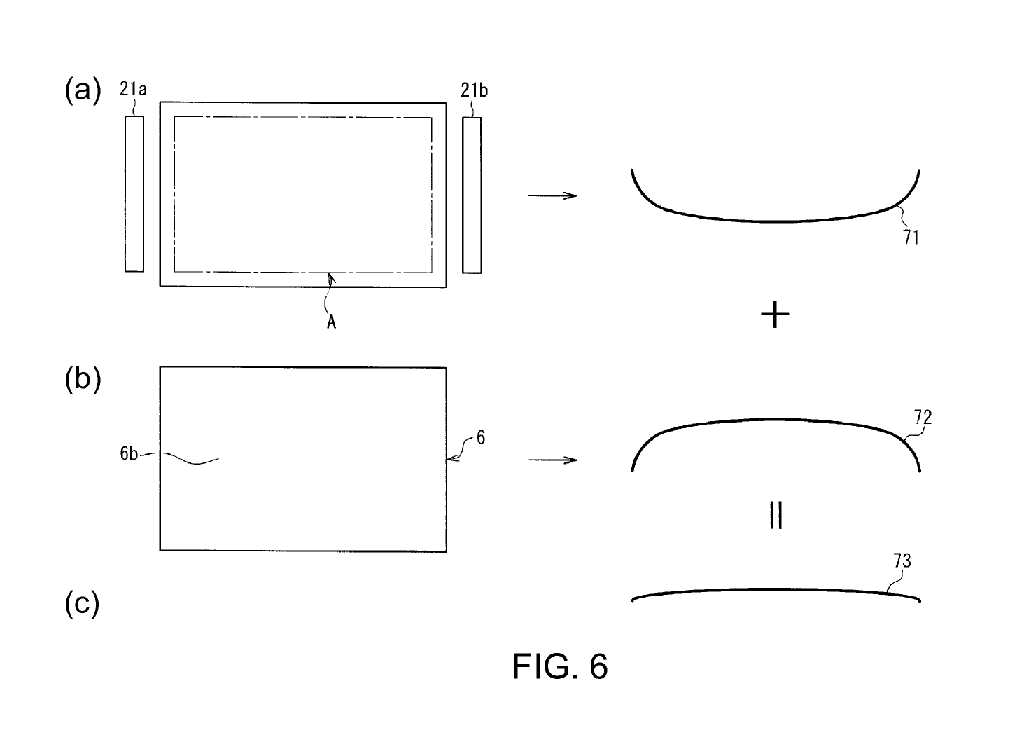

Next, the luminance distribution during operation of the liquid crystal display device 1 of the present embodiment will be specifically described with reference to FIG. 6.

FIGS. 6(a), 6(b), and 6(c) respectively show the luminance distribution of the liquid crystal panel alone, the luminance distribution of the light guide plate shown in FIG. 2 alone, and the luminance distribution of the entire liquid crystal display device.

As shown in the curve 71 in FIG. 6(a), in the liquid crystal panel 2 alone, the edges near the first and second gate drivers 21a and 21b are brighter than the central portion due to insufficient charging of the pixels P resulting from resistance in the gate lines G. The luminance distribution of the liquid crystal panel 2 alone is the luminance distribution of light outputted from the liquid crystal panel 2 when an illumination light of even luminance is radiated on the liquid crystal panel 2 that displays information at a prescribed gradation value (an intermediate gradation value in 256-gradation, for example).

Also, in the backlight device 3 of the present embodiment, by adjusting the luminance distribution of illumination light from the light guide plate 6 to the liquid crystal panel 2, the luminance distribution of light outputted from the liquid crystal display device 1 can be made substantially even. In the backlight device 3 of the present embodiment, the luminance distribution of optical members besides the light guide plate 6 such as the reflective sheet 8 and the prism sheet 11 is set so as to be substantially even in the surface (display surface) of the liquid crystal panel 2.

Specifically, in the light guide plate 6, as shown in the curve 72 in FIG. 6(b), the luminance distribution thereof is set by changing the light-emitting rate in respective portions of the light-emitting surface 6b. Specifically, by changing the density of dot patterns or creases in respective portions of the light guide plate 6, the luminance of illumination light in in the central portion of the liquid crystal panel 2 can be made greater than in the edge portions of the liquid crystal panel 2. As a result, as shown in the curve 73 of FIG. 6(c), the luminance distribution of light outputted from the liquid crystal display device 1 as a whole is adjusted so as to be substantially even due to the luminance distribution of the liquid crystal panel 2 alone and the luminance distribution of the light guide plate 6 (backlight device 3) offsetting each other.

In the liquid crystal display device 1 of the present embodiment configured as described above, the luminance distribution of illumination light from the backlight device 3 (backlight unit) to the liquid crystal panel 2 (display unit) is adjusted on the basis of the luminance distribution of the liquid crystal panel 2 alone such that the luminance distribution of light outputted from the liquid crystal panel 2 becomes substantially even. As a result, in the liquid crystal display device 1 of the present embodiment, unlike in the conventional example, even if the liquid crystal panel 2 is made large, it is possible to prevent uneven luminance in the light outputted from the liquid crystal panel 2, thus allowing display quality to be improved.

In the present embodiment, the backlight device 3 is provided with the light guide plate 6 that guides light from the light-emitting diodes 4 (light source) in a prescribed direction and outputs the light to the liquid crystal panel 2, and in the backlight device 3, the luminance distribution of illumination light to the liquid crystal panel 2 is adjusted based on the luminance distribution in the liquid crystal panel 2 such that the luminance distribution of the light outputted from the liquid crystal panel 2 is substantially even, by changing the light-emitting rate in the respective portions of the light-emitting surface 6b of the light guide plate 6. In other words, in the present embodiment, by changing the light-emitting rate in each of the portions of the light-emitting surface 6b of the light guide plate 6, even if the liquid crystal panel 2 is made large, it is possible to improve the display quality of the liquid crystal display device 1.

### Embodiment 2

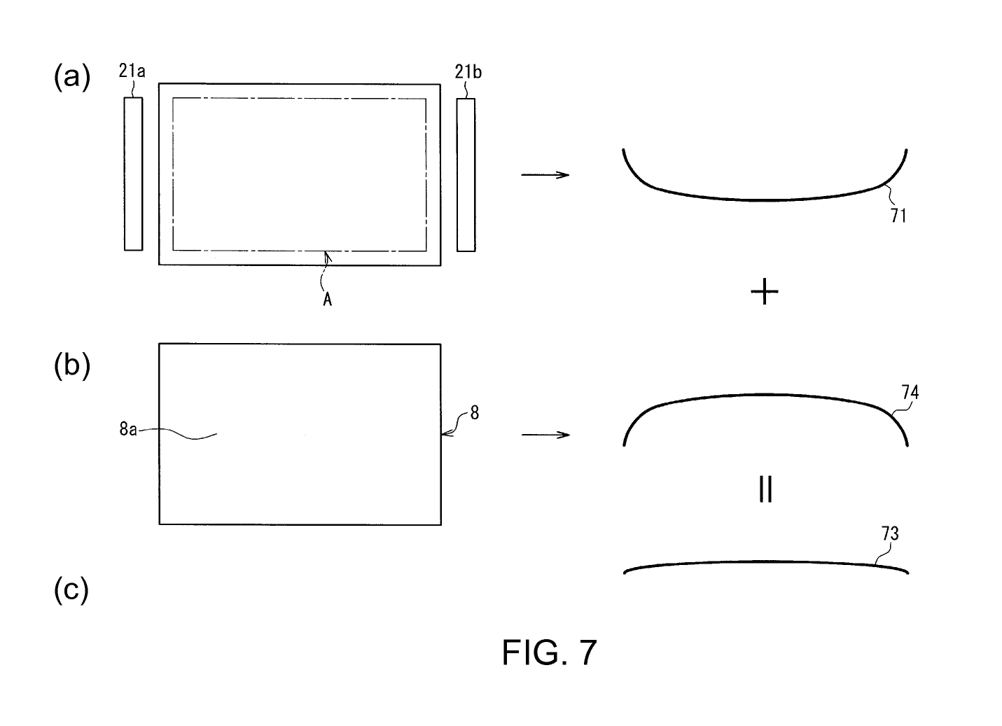

FIGS. 7(a), 7(b), and 7(c) respectively show a luminance distribution of a liquid crystal panel alone, a luminance distribution of a reflective sheet alone, and a luminance distribution of the entire liquid crystal display device according to Embodiment 2.

In the drawings, the main difference between the present embodiment and Embodiment 1 is that in the backlight device, the reflectance of respective portions of the reflective sheet (reflective unit) is changed such that the luminance distribution of the illumination device to the liquid crystal panel is adjusted according to the luminance distribution of the liquid crystal panel alone such that the luminance distribution of the light outputted from the liquid crystal panel is substantially even. The same reference characters are given to elements that are in common with Embodiment 1 above, and duplicative descriptions are omitted.

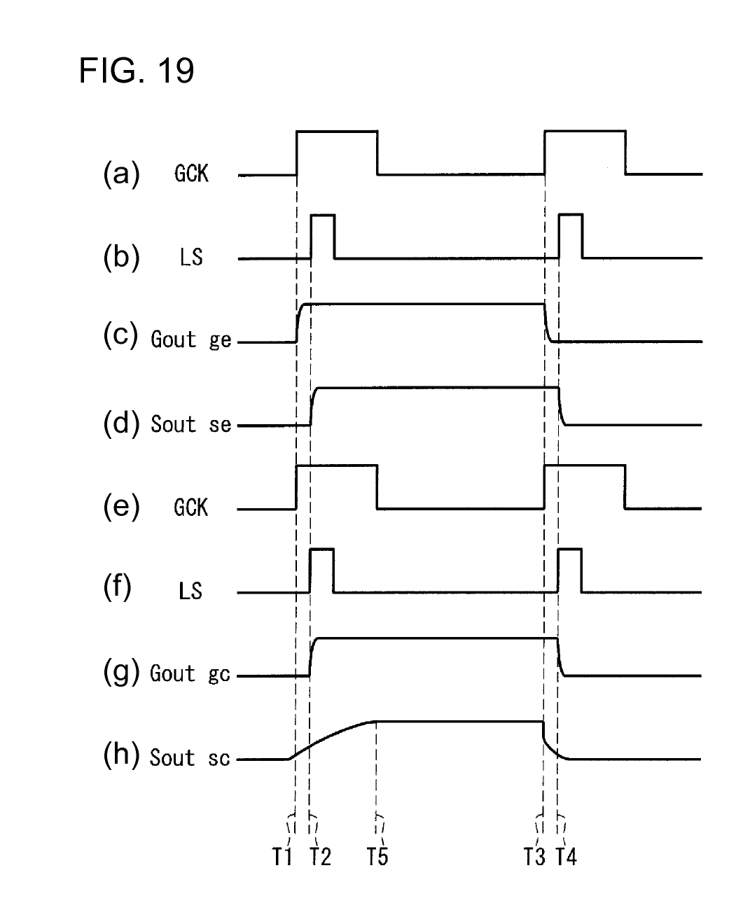

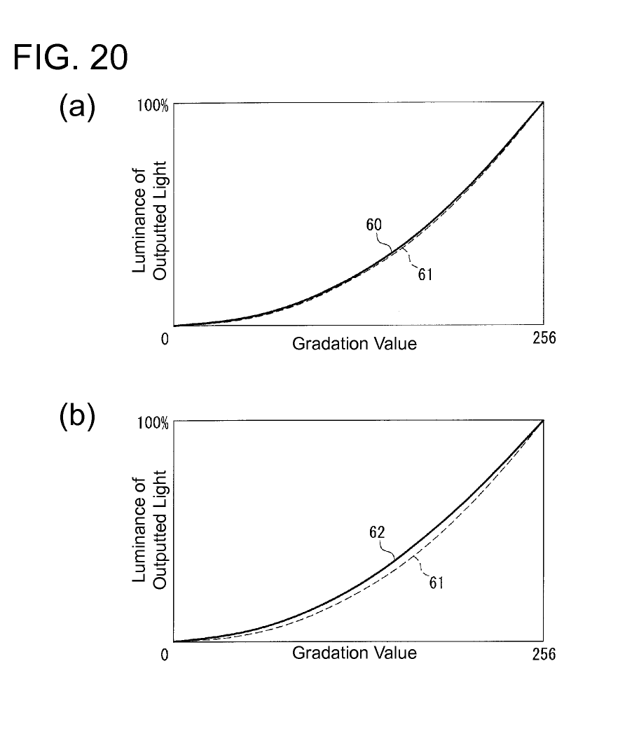

In other words, like Embodiment 1, as shown in the curve 71 of FIG. 7(a), in the liquid crystal panel 2 alone, the luminance of edge portions close to first and second gate drivers 21a and 21b is greater than in a central portion due to the pixels P not being charged to a sufficient degree due to resistance in gate lines G (refer to FIGS. 19 and 20). The luminance distribution of the liquid crystal panel 2 alone is the luminance distribution of light outputted from the liquid crystal panel 2 when an illumination light of even luminance is radiated on the liquid crystal panel 2 that displays information at a prescribed gradation value (an intermediate gradation value in 256-gradation, for example).

In the backlight device 3 of the present embodiment, the luminance distribution of illumination light from the reflective sheet 8 towards the liquid crystal panel 2 is adjusted, thereby making the luminance distribution of light outputted from the liquid crystal display device 1 substantially even. The backlight device 3 of the present embodiment is configured such that the luminance distribution of light to the surface (display surface) of the liquid crystal panel 2 from optical members other than the reflective sheet 8 such as the light guide plate 6 and the prism sheet 11 is substantially even.

Specifically, as shown in the curve 74 of FIG. 7(b), the luminance distribution of the reflective sheet 8 is set by changing the reflectance of the respective portions of the light-emitting surface 8a. Specifically, in the reflective sheet 8, the reflectance of light towards the liquid crystal panel 2 in the respective portions is changed, and thus, the luminance of illumination light in the central portion of the liquid crystal panel 2 is greater than the luminance of illumination light in the edge portions of the liquid crystal panel 2. As a result, in the liquid crystal display device 1 as a whole, as shown in the curve 73 of FIG. 6(c), the luminance distribution of the light outputted therefrom is adjusted to be substantially even due to the luminance distribution of the liquid crystal panel 2 alone and the luminance distribution of the reflective sheet 8 (backlight device 3) offsetting each other.

With the above-mentioned configuration, in the present embodiment, functions and effects similar to those in Embodiment 1 above can be achieved. Also, in the present embodiment, the backlight device 3 (backlight unit) is provided with the reflective sheet 8 (reflective unit) that reflects light from the light-emitting diodes 4 (light source) back towards the liquid crystal panel 2 (display unit), and in the backlight device 3, the luminance distribution of the illumination light to the liquid crystal panel 2 is adjusted on the basis of the luminance distribution of the liquid crystal panel 2 alone such that the luminance distribution of light outputted from the liquid crystal panel 2 is substantially even, by changing the reflectance of the respective portions of the reflective sheet 8. In other words, in the present embodiment, by changing the reflectance in each of the portions of the reflective sheet 8, even if the liquid crystal panel 2 is made large, it is possible to improve the display quality of the liquid crystal display device 1.

### Embodiment 3

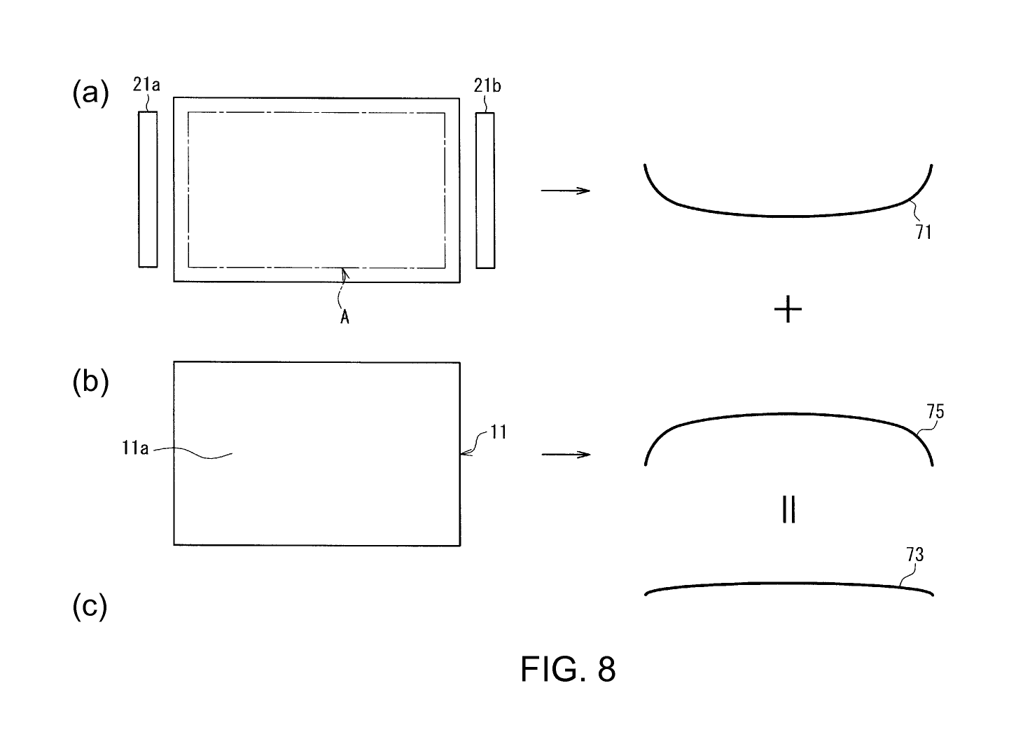

FIGS. 8(a), 8(b), and 8(c) respectively show a luminance distribution of a liquid crystal panel alone, a luminance distribution of a prism sheet alone, and a luminance distribution of the entire liquid crystal display device according to Embodiment 3.

In the drawings, the main difference between the present embodiment and Embodiment 1 is that in the backlight device, the rate of light collection in the respective portions of the prism sheet is changed in order to adjust the luminance distribution of illumination light to the liquid crystal panel on the basis of the luminance distribution of the liquid crystal panel alone such that the luminance distribution of light outputted from the liquid crystal panel is substantially even. The same reference characters are given to elements that are in common with Embodiment 1 above, and duplicative descriptions are omitted.

In other words, like Embodiment 1, as shown in the curve 71 of FIG. 8(a), in the liquid crystal panel 2 alone, the luminance of edge portions close to first and second gate drivers 21a and 21b is greater than in a central portion due to the pixels P not being charged to a sufficient degree due to resistance in gate lines G (refer to FIGS. 19 and 20). The luminance distribution of the liquid crystal panel 2 alone is the luminance distribution of light outputted from the liquid crystal panel 2 when an illumination light of even luminance is radiated on the liquid crystal panel 2 that displays information at a prescribed gradation value (an intermediate gradation value in 256-gradation, for example).

In the backlight device 3 of the present embodiment, the luminance distribution of illumination light from the prism sheet 11 towards the liquid crystal panel 2 is adjusted, thereby making the luminance distribution of light outputted from the liquid crystal display device 1 substantially even. In the backlight device 3 of the present embodiment, the luminance distribution of optical members besides the prism sheet 11 such as the light guide plate 6 and the reflective sheet 8 is set so as to be substantially even in the surface (display surface) of the liquid crystal panel 2.

Specifically, as shown in the curve 75 of FIG. 8(b), the luminance distribution of the prism sheet 11 is set by changing the rate of light collection in the respective portions of the light-emitting surface 11a. Specifically, in the prism sheet 11, the rate of collection of light traveling towards the liquid crystal panel 2 in the respective portions is changed, and thus, the luminance of illumination light in the central portion of the liquid crystal panel 2 is greater than the luminance of illumination light in the edge portions of the liquid crystal panel 2. As a result, as shown in the curve 73 of FIG. 6(c), the luminance distribution of light outputted by the liquid crystal display device 1 as a whole is adjusted so as to be substantially even due to the luminance distribution of the liquid crystal panel 2 alone and the luminance distribution of the prism sheet 11 (backlight device 3) offsetting each other.

With the above-mentioned configuration, in the present embodiment, functions and effects similar to those in Embodiment 1 above can be achieved. Also, in the present embodiment, the backlight device 3 (backlight unit) is provided with a prism sheet 11 that collects illumination light to be emitted towards the liquid crystal panel (display unit), and in the backlight device 3, the luminance distribution of the illumination light to the liquid crystal panel 2 may be adjusted by changing the rate of light collection in the respective portions of the prism sheet 11 on the basis of the luminance distribution of the liquid crystal panel 2 alone such that the luminance distribution of light outputted from the liquid crystal panel 2 is substantially even. In other words, in the present embodiment, by changing the rate of light collection in each of the portions of the prism sheet 11, even if the liquid crystal panel 2 is made large, it is possible to improve the display quality of the liquid crystal display device 1.

### Embodiment 4

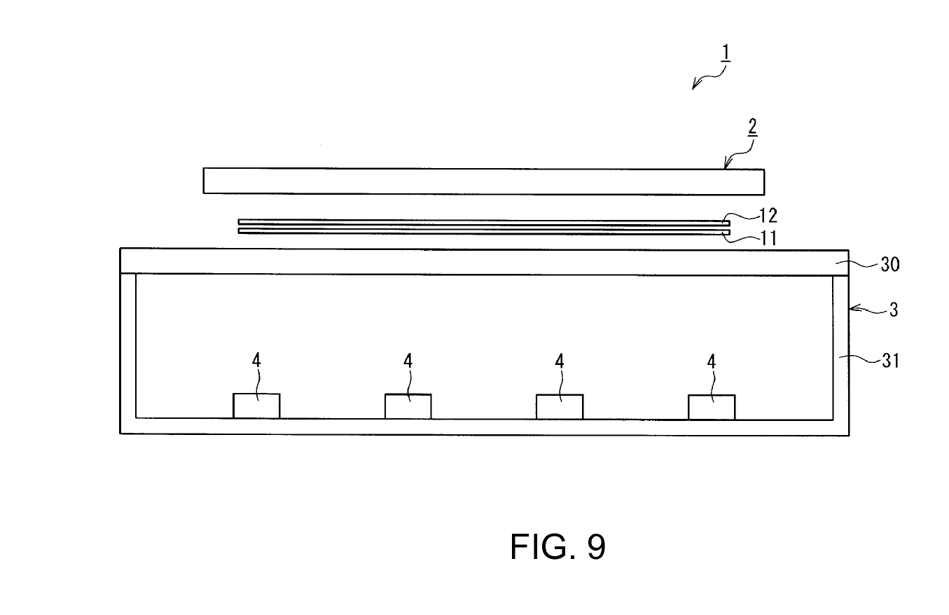

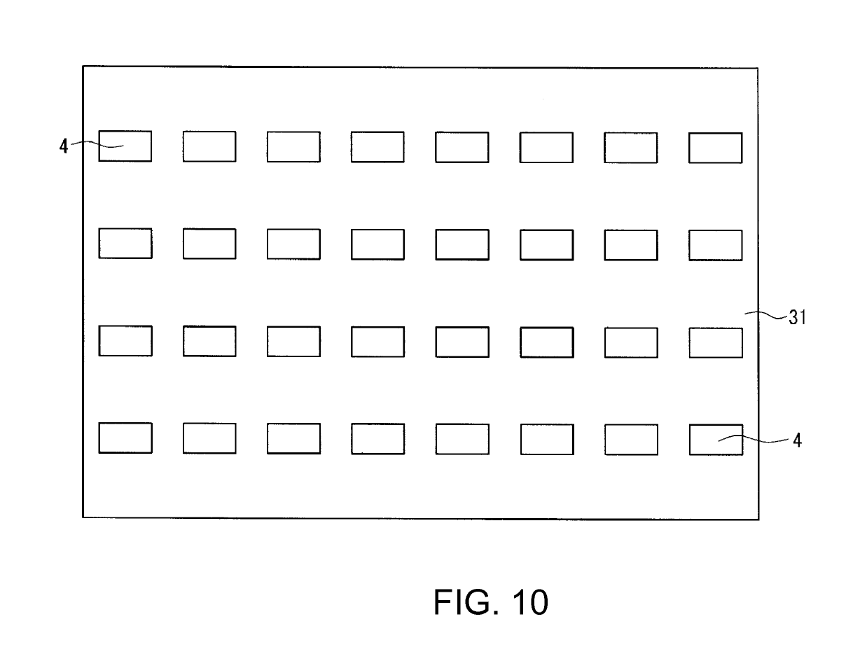

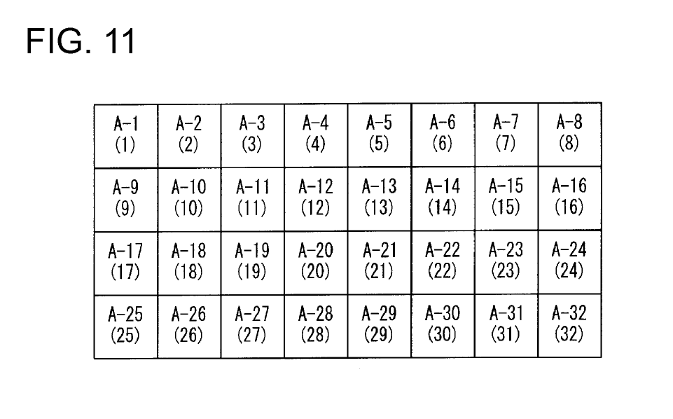

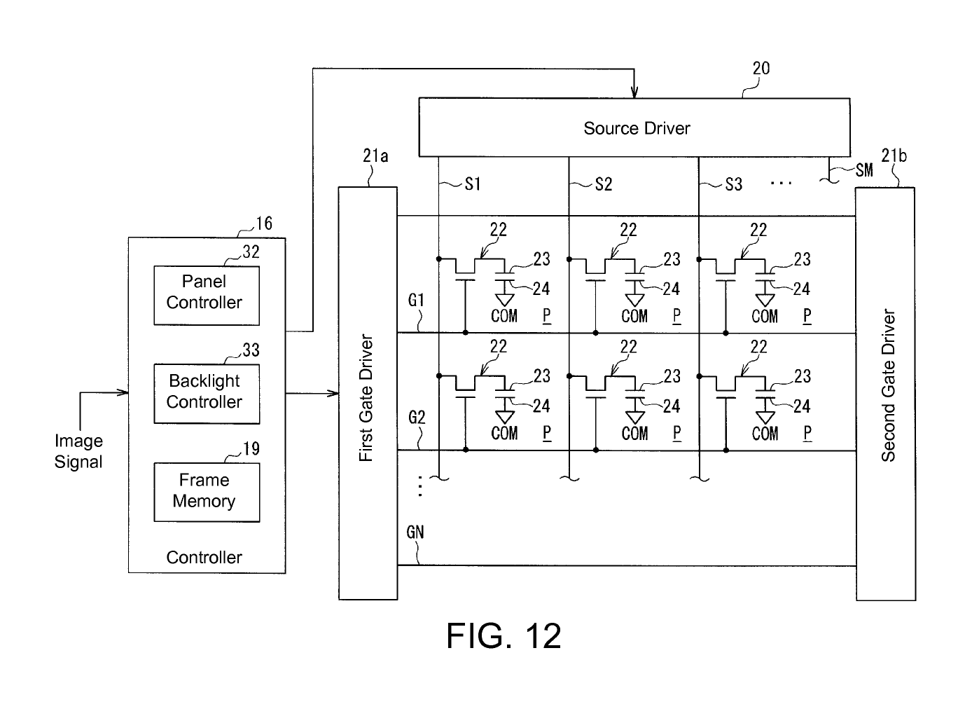

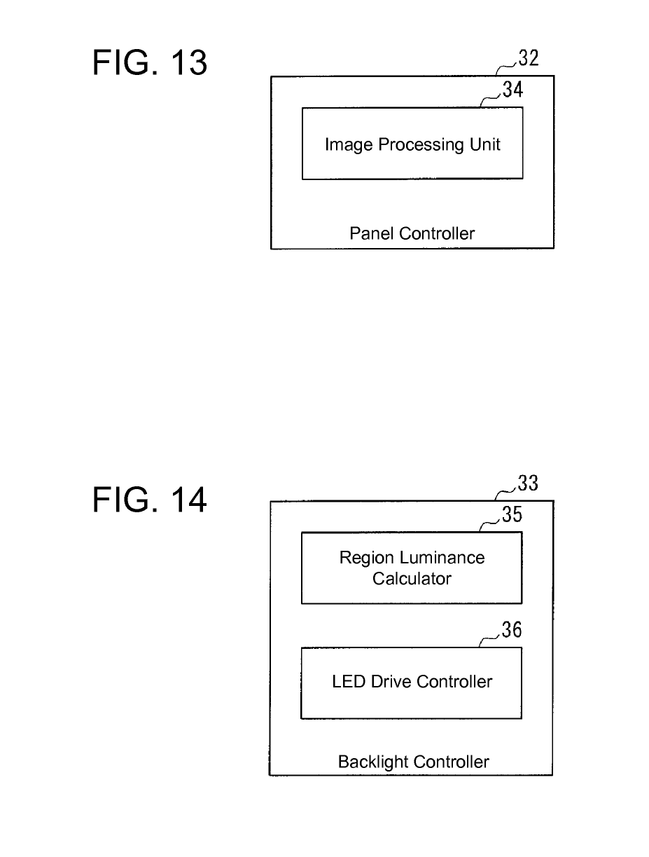

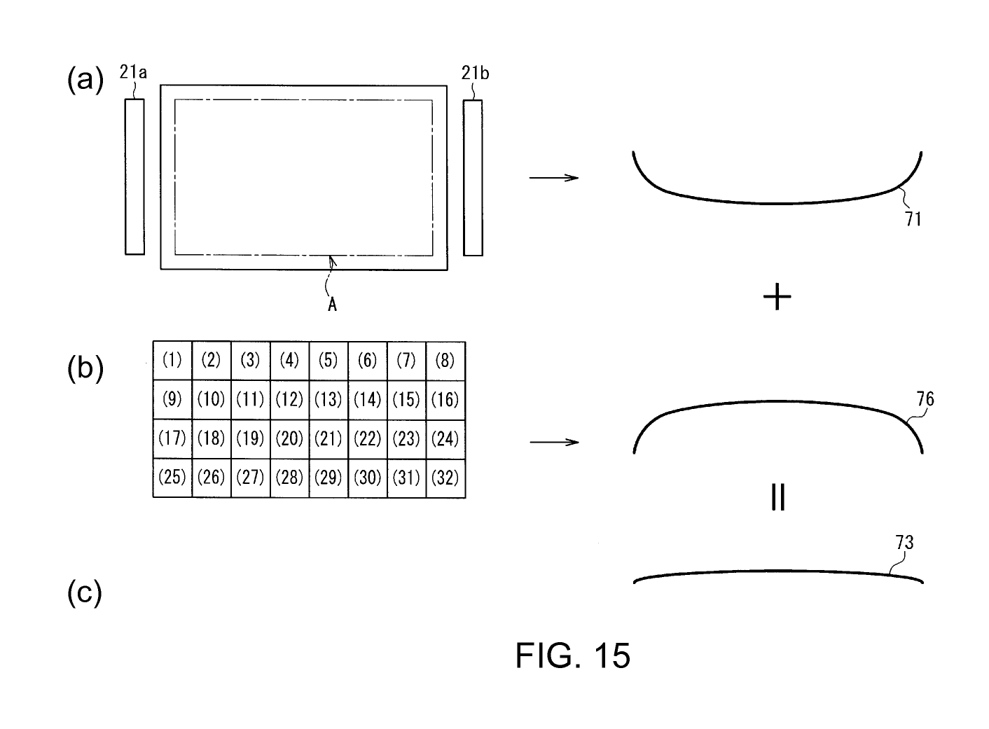

FIG. 9 is a view showing a liquid crystal display device according to Embodiment 4 of the present invention. FIG. 10 is a drawing for describing main components of a backlight device shown in FIG. 9. FIG. 11 is a drawing for describing a specific example of a plurality of light-emitting areas provided in the backlight device shown in FIG. 9 and a plurality of display areas illuminated by light from the light-emitting areas. FIG. 12 is a view showing the configuration of main components of the liquid crystal panel shown in FIG. 9. FIG. 13 is a block diagram showing a configuration example of a panel controller shown in FIG. 12. FIG. 14 is a block diagram showing a configuration example of a backlight controller shown in FIG. 12. FIGS. 15(a), 15(b), and 15(c) respectively show a luminance distribution of a liquid crystal panel alone, a luminance distribution of a backlight device alone, and a luminance distribution of the entire liquid crystal display device according to Embodiment 4.

The main differences between the present embodiment and Embodiment 1 are that a plurality of display areas are provided in the liquid crystal panel, that the backlight device is provided with a plurality of light-emitting areas that respectively emit light from the light source to the plurality of display areas, that the controller is configured so as to perform drive control of the liquid crystal panel and the backlight device using an inputted image signal, and that the backlight device adjusts the luminance distribution of illumination light to the liquid crystal panel on the basis of the luminance distribution of the liquid crystal panel alone by changing the luminance of light from the plurality of light-emitting areas such that the luminance distribution of light outputted from the liquid crystal panel is substantially even. The same reference characters are given to elements that are in common with Embodiment 1 above, and duplicative descriptions are omitted.

As shown in FIG. 9, in the liquid crystal display device 1 of the present embodiment, a direct-lit backlight device 3 is used as the backlight unit. The backlight device 3 is open on the liquid crystal panel 2 side and includes a case 31 that houses light emitting diodes 4 and a diffusion plate 30 provided so as to cover the opening of the case 31.

As shown in the example of FIG. 10, in the backlight device 3, a total of 32 light-emitting diodes 4 are disposed in the case 31.

Also, as shown in FIG. 11, the backlight device 3 of the present embodiment has a plurality of light-emitting areas (1) to (32) that respectively output light from the light emitting diodes 4 (light source) to the respective plurality of display areas A-1 to A-32 provided in the liquid crystal panel 2 (display unit). In other words, one light-emitting diode 4 is provided for each of the light-emitting areas (1) to (32), and illumination light is radiated on the corresponding display areas A-1 to A-32.

In the liquid crystal display device 1 of the present embodiment, there is a one-to-one relation between the light-emitting areas (1) to (32) arranged in a matrix and the display areas A-1 to A-32 arranged in a matrix, thus forming an area-active (local dimming) backlight that appropriately illuminates each display area with illumination light from one light-emitting area on the basis of information to be displayed.

Specifically, as shown in FIG. 12, the controller 16 of the present embodiment is provided with a panel controller 32 and a backlight controller 33. The panel controller 32 and the backlight controller 33 are configured so as to be able to perform drive control respectively on the liquid crystal panel 2 (display unit) and the backlight device 3 (backlight unit) using an image signal inputted to the controller 16.

As shown in FIG. 13, the panel controller 32 of the present embodiment is provided with an image processing unit 34. The image processing unit 34 performs prescribed image processing including gradation correction that determines a correction value for the gradation value for each pixel P included in the inputted image signal using the illumination state of the light-emitting diodes 4 (light source) corresponding to the plurality of light-emitting areas (1) to (32).

In addition, in the panel controller 32, luminance values of the respective light-emitting areas are sent from a region luminance calculator to be described later provided in the backlight controller 33, and after the command signals to the source drivers 20 are corrected to a signal that reflects the sent luminance values of the respective light-emitting areas, the signal is outputted from the panel controller 32 to the source drivers 20 (details described later).

Also, the image processing unit 34 receives luminance values of the respective light-emitting areas from the region luminance calculator. The luminance value of each light-emitting area is a luminance value that has been corrected using the luminance values of the surrounding light-emitting areas, and is a value that takes into account the impact of crosstalk from light from the surrounding light-emitting areas. The image processing unit 34 uses the luminance values of the respective light-emitting areas to generate and output command signals to the source drivers 20 of the corresponding display areas.

As shown in FIG. 14, the backlight controller 33 is provided with the region luminance calculator 35 and the LED drive controller 36. The region luminance calculator 35 obtains, from the inputted image signal, luminance information of the pixels P included in the corresponding display areas for each of the light-emitting areas. Also, the region luminance calculator 35 uses the obtained luminance information of the pixels P to perform luminance calculation of calculating the luminance of each of the colors red, green, and blue in the respective light-emitting areas (details described later).

Furthermore, the region luminance calculator 35 performs region crosstalk correction to be described later on the luminance values of each color obtained by the luminance calculation, thereby obtaining the post-correction luminance values of each of the colors that takes into account the effect of crosstalk from light from the surrounding light-emitting areas. The region luminance calculator 35 outputs the post-correction luminance values of the respective colors obtained for the respective light-emitting areas to the image processing unit 34 and the LED drive controller 36.

Here, the luminance calculation and the region crosstalk correction in the region luminance calculator 35 will be described. In the description below, an example will be described in which the luminance value of the light-emitting area (10) located in the center of a group of nine light-emitting areas (1), (2), (3), (9), (10), (11), (17), (18), and (19) is obtained.

In the region luminance calculator (35), luminance calculations are performed on the images signals for the nine display areas A-1, A-2, A-3, A-9, A-10, A-11, A-17, A-18, and A-19 respectively corresponding to the light-emitting areas (1), (2), (3), (9), (10), (11), (17), (18), and (19). By respectively performing the luminance calculations, the luminance values of the respective colors red, green, and blue are determined for the corresponding light-emitting areas (1), (2), (3), (9), (10), (11), (17), (18), and (19).

Specifically, the region luminance calculator 35 obtains from a frame memory 19 the luminance values of a plurality of pixels P (640×360 pixels P, for example) included in the display area A-1. The region luminance calculator 35 performs luminance calculation on the obtained luminance information, thus extracting data concerning the largest luminance value, for example, for each of the colors red, blue, and green, the data being designated as the luminance values for the respective colors in the light-emitting area (1) corresponding to the display area A-1. In other words, the region luminance calculator 35 performs luminance calculation, and thus, among the plurality of pixels P included in the display area A-1, the luminance value for red in the light-emitting area (1) is selected as the luminance value for the pixel P that should display red at the greatest luminance.

In the luminance calculation, filtering is performed to remove noise, thus reliably removing negative effects from noise. In other words, the region luminance calculator 35 is configured such that in a case in which there is a pixel P with an abnormally high luminance value compared to the surrounding pixels P due to noise, this luminance value is prevented from being extracted as the maximum luminance value.

Similarly, among the plurality of pixels P included in the display area A-1, the luminance value of the pixel P that should display green at the greatest luminance is selected as the luminance value for green in the light-emitting area (1). Similarly, among the plurality of pixels P included in the display area A-1, the luminance value of the pixel P that should display blue at the greatest luminance is selected as the luminance value for blue in the light-emitting area (1). The region luminance calculator 35 sets the luminance values of the light-emitting area (1) as the luminance values for each of the selected colors red, blue, and green.

The region luminance calculator 35 similarly obtains the luminance value of the colors red, blue, and green in the light-emitting areas (2), (3), (9), (10), (11), (17), (18), and (19). In the region luminance calculator 35, region crosstalk correction is performed for the luminance values in the light-emitting area (10) for each color red, blue, and green on the basis of the luminance values of the surrounding light-emitting areas (1), (2), (3), (9), (11), (17), (18), and (19).

In the region crosstalk correction, the region luminance calculator 35 uses a correction coefficient stored in a memory (not shown) in order to corrected the obtained luminance values, and thus, corrected luminance values for each of the light-emitting areas are calculated for each of the colors red, blue, and green.

In other words, in the light-emitting area (10), for example, the luminance of each of the colors red, blue, and green is increased due to the light from the surrounding light-emitting areas (1), (2), (3), (9), (11), (17), (18), and (19). Then, by using experiment or simulation results or the like from an actual product, the correction coefficient is predetermined so as to offset the increase in luminance in the respective colors red, blue, and green, and the correction coefficient is stored in the memory. The region luminance calculator 35 uses the luminance values of the respective colors in the light-emitting area (10) obtained by luminance calculation, and the correction coefficient stored in the memory is used to calculate the post-correction luminance values of the respective colors in the light-emitting area (10). The region luminance calculator 35 outputs the post-correction luminance values of the respective colors obtained for the respective light-emitting areas to the image processing unit 34 and the LED drive controller 36.

The above-mentioned correction coefficient is determined by experiment or simulation results or the like using an actual product, and thus, takes into consideration changes in luminance due to the internal structure of the liquid crystal panel 2, the presence or lack of a diffusion plate and optical sheets, or the like, and thus, it is possible to improve the display quality with greater ease by reliably removing the effect of crosstalk in the liquid crystal display device 1.

Returning to FIG. 14, the LED drive controller 36 has a drive controller that performs illumination driving of the light source, and determines the illumination period of corresponding light-emitting diodes 4 on the basis of the post-correction luminance values in the plurality of light-emitting areas from the region luminance calculator 35, and drives the light-emitting diodes 4 by PWM on the basis of the determined illumination period. In other words, in the LED drive controller 36, the ON/OFF duty of PWM is determined on the basis of the luminance values determined in the region luminance calculator 35, and signals that dictate the determined ON/OFF duty are outputted as command signals to an illumination driver circuit (not shown). The illumination driver circuit supplies power to the respective light-emitting diodes 4 on the basis of the command signals, thus performing illumination driving on the respective light-emitting diodes 4.

On the other hand, once the image processing unit 34 receives from the region luminance calculator 35 the luminance values of the respective colors red, green, and blue in the respective light-emitting areas (1) to (32), the image processing unit 34 uses these luminance values to correct the command signals to the source drivers 20, thus outputting these as new command signals to the source drivers 20.

In the liquid crystal display device 1 of the present embodiment, as shown in the curve 71 of FIG. 15(a), as in Embodiment 1, in the liquid crystal panel 2 alone, edge portions close to the first and second gate drivers 21a and 21b are brighter than the central portion due to insufficient charging of the pixels P resulting from resistance in the gate lines G (refer to FIGS. 19 and 20). The luminance distribution of the liquid crystal panel 2 alone is the luminance distribution of light outputted from the liquid crystal panel 2 when an illumination light of even luminance is radiated on the liquid crystal panel 2 that displays information at a prescribed gradation value (an intermediate gradation value in 256-gradation, for example).

In the backlight device 3 of the present embodiment, the luminance of light from the plurality of light-emitting areas (1) to (32) is changed, and thus, the luminance distribution of light outputted from the liquid crystal display device 1 is substantially even. In the backlight device 3 of the present embodiment, the luminance distribution of other optical members such as the light guide plate 6, the reflective sheet 8, and the prism sheet 11 is set so as to be substantially even in the surface (display surface) of the liquid crystal panel 2.

Specifically, in the backlight device 3, as shown in the curve 76 of FIG. 15(b), the luminance distribution thereof is set by changing the luminance of light from the respective plurality of light-emitting areas (1) to (32). Specifically, in the backlight device 3, by changing the luminance of the light-emitting diodes 4 in the corresponding light-emitting areas, the luminance of illumination light in the central portion of the liquid crystal panel 2 (that is, the luminance of illumination light from the light-emitting areas (4), (12), (20), (28), (5), (13), (21), and (29)) is set to be greater than the luminance of illumination light to the edge portions of the liquid crystal panel 2 (that is, the luminance of illumination light from the light-emitting areas (1), (9), (17), (25), (8), (16), (24), and (32)). As a result, as shown in the curve 73 of FIG. 15(c), the luminance distribution of light outputted from the liquid crystal display device 1 as a whole is adjusted so as to be substantially even due to the luminance distribution of the liquid crystal panel 2 alone and the luminance distribution of the backlight device 3 offsetting each other.

With the above-mentioned configuration, in the present embodiment, functions and effects similar to those in Embodiment 1 above can be achieved. Also, in the present embodiment, in the liquid crystal panel 2 (display unit), a plurality of display areas A-1 to A-32 are provided, and in the backlight device (backlight unit), a plurality of light-emitting areas (1) to (32) that radiate light from the light-emitting diodes (light source) to the respective plurality of display areas A-1 to A-32 are provided. The controller 16 performs drive control on the liquid crystal panel 2 and the backlight device 3 on the basis of inputted image signals. Furthermore, in the backlight device 3 the luminance distribution of illumination light to the liquid crystal panel 2 may be adjusted on the basis of the luminance distribution of the liquid crystal panel 2 alone such that the luminance distribution of light outputted from the liquid crystal panel 2 is made substantially even by changing the luminance of light from the plurality of light-emitting areas (1) to (32). In other words, in the present embodiment, by changing the luminance of the light from the plurality of light-emitting areas (1) to (32), it is possible to have a liquid crystal display device 1 with which it is possible to improve display quality even when the liquid crystal panel 2 is made large.

### Embodiment 5

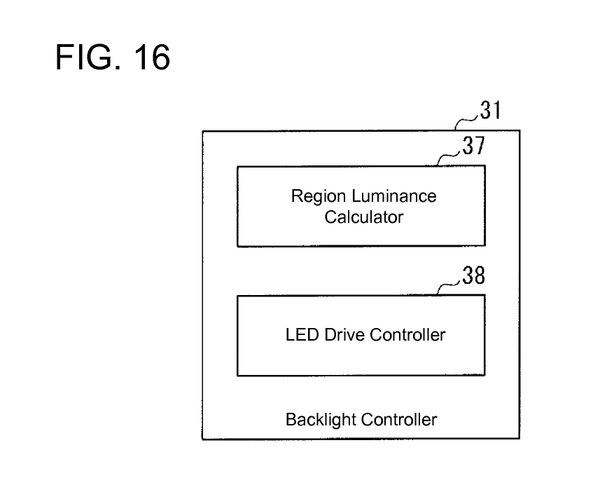

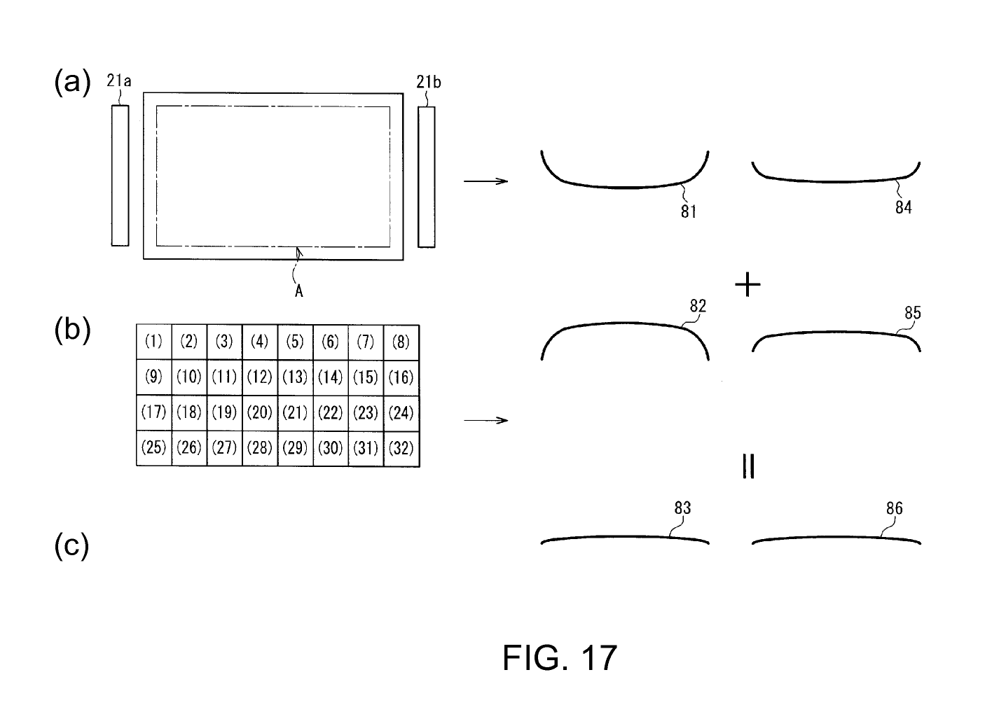

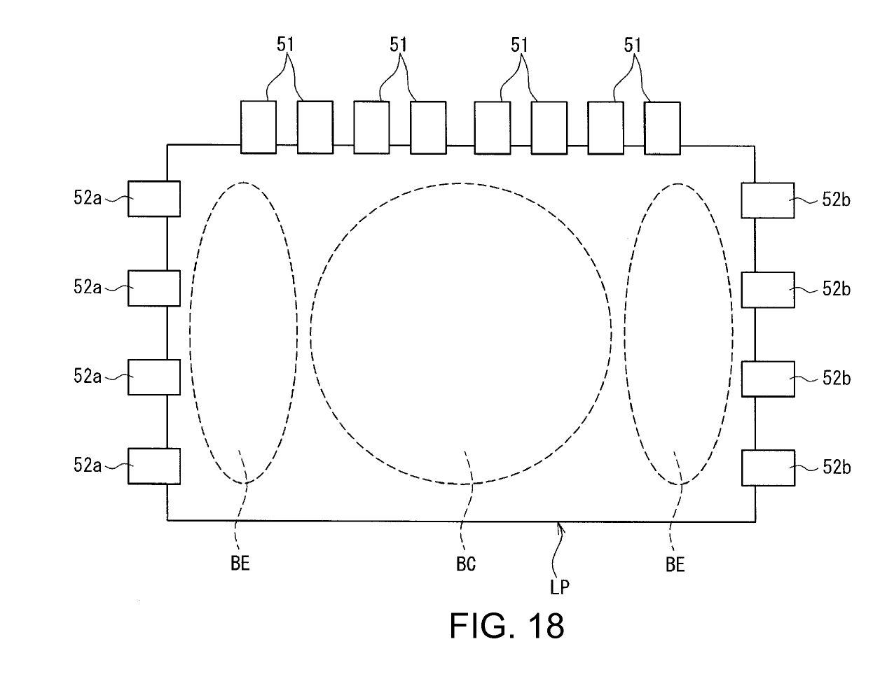

FIG. 16 is a block diagram showing a configuration example of a backlight controller in a liquid crystal display device of Embodiment 5. FIGS. 17(a), 17(b), and 17(c) respectively show a luminance distribution of a liquid crystal panel alone, a luminance distribution of a backlight device alone, and a luminance distribution of the entire liquid crystal display device according to Embodiment 5.

In the drawings, the main difference between the present embodiment and Embodiment 4 is that the luminance of light from a respective plurality of light-emitting areas is changed on the basis of gradation values in the liquid crystal panel. The same reference characters are given to elements that are in common with Embodiment 4 above, and duplicative descriptions are omitted.

In other words, as shown in FIG. 16, a region luminance calculator 37 and an LED drive controller 38 are provided in the backlight controller 33 of the present embodiment. Also, the backlight device 3 of the present embodiment is configured so as to change the luminance of light from the plurality of light-emitting areas (1) to (32) on the basis of the gradation values in the liquid crystal panel 2.

Specifically, the region luminance calculator 37 has a similar configuration to the region luminance calculator 35 of Embodiment 4, and in the respective light-emitting areas (1) to (32), the region luminance calculator 37 performs region crosstalk correction.

On the other hand, the LED drive controller 38 is configured so as to change the luminance of the light from the plurality of light-emitting areas (1) to (32) on the basis of the gradation values of the liquid crystal panel 2 included in the inputted image signal in addition to the functions of the LED drive controller 36 of Embodiment 4. Specifically, the LED drive controller 38 determines an average gradation value for all pixels P included in the inputted image signal, and determines whether the average gradation value is less than a first prescribed value, or greater than or equal to a second prescribed value. If the LED drive controller 38 determines that the average gradation value is less than the first prescribed value, it determines that low gradation display is being performed in the liquid crystal panel 2, and illuminates the corresponding light-emitting diodes 4 so as to greatly decrease the luminance of the light-emitting diodes 4 in the light-emitting areas in the edge portions of the liquid crystal panel 2 compared to the luminance of the light-emitting diodes 4 in the light-emitting areas corresponding to the central portion of the liquid crystal panel 2.

On the other hand, if the LED drive controller 38 determines that the average gradation value is greater than or equal to the second prescribed value, it determines that high gradation display is being performed in the liquid crystal panel 2, and illuminates the corresponding light-emitting diodes 4 such that the luminance of the light-emitting diodes 4 in the light-emitting areas corresponding to the edge portions of the liquid crystal panel 2 is substantially the same as the luminance of the light-emitting diodes 4 in the light-emitting areas corresponding to the central portion of the liquid crystal panel 2.

If the LED drive controller 38 determines that the average gradation value is greater than or equal to the first prescribed value and less than the second prescribed value, it determines that intermediate gradation display is being performed on the liquid crystal panel 2, and illuminates the corresponding light-emitting diodes 4 such that the luminance of the light-emitting diodes 4 in the light-emitting areas corresponding to the edges of the liquid crystal panel 2 is slightly smaller than the luminance of the light-emitting diodes 4 in the light-emitting areas corresponding to the central portion of the liquid crystal panel 2, in contrast to a case in which low gradation display is performed.

Specifically, the liquid crystal panel 2 alone has a high degree of unevenness in luminance distribution during low gradation display shown in the curve 81 of FIG. 17(a) compared to high gradation display shown in the curve 84 of FIG. 17(a). In other words, in the liquid crystal panel 2 alone, the luminance distribution becomes more uneven during low gradation display.

In the backlight device 3, when low gradation display is being performed, the illumination of the corresponding light-emitting diodes 4 is changed such that the luminance of the light-emitting diodes 4 in the light-emitting areas corresponding to the edge portion of the liquid crystal panel 2 is much less than the luminance of the light-emitting diodes 4 in the light-emitting areas corresponding to the central portion of the liquid crystal panel 2 in the luminance distribution shown in the curve 82 in FIG. 17(b).

Specifically, in the backlight device 3, by changing the luminance of the light-emitting diodes 4 corresponding to the light-emitting areas, the luminance of illumination light to the central portion of the liquid crystal panel 2 (that is, the luminance of illumination light from the light-emitting areas (4), (12), (20), (28), (5), (13), (21), and (29)) are set to be much greater than the luminance of illumination light to the edge portions of the liquid crystal panel 2 (that is, the luminance of illumination light from the light-emitting areas (1), (9), (17), (25), (8), (16), (24), and (32)). As a result, as shown in the curve 83 of FIG. 17(c), the luminance distribution of light outputted from the liquid crystal display device 1 is adjusted so as to be substantially even due to the luminance distribution of the liquid crystal panel 2 alone and the luminance distribution of the backlight device 3 offsetting each other.

On the other hand, in the backlight device 3, when high gradation display is being performed, the illumination of the corresponding light-emitting diodes 4 is changed such that the luminance of the light-emitting diodes 4 in the light-emitting areas corresponding to the edge portions of the liquid crystal panel 2 is substantially the same as the luminance of the light-emitting diodes 4 in the light-emitting areas corresponding to the central portion of the liquid crystal panel 2 in the luminance distribution of the curve 85 of FIG. 17(b).

Specifically, in the backlight device 3, by changing the luminance of the light-emitting diodes 4 corresponding to the light-emitting areas, the luminance of the illumination light to the edge portions of the liquid crystal panel 2 (that is, the luminance of illumination light from the light-emitting areas (1), (9), (17), (25), (8), (16), (24), and (32)) is substantially the same as the luminance of the illumination to the central portion of the liquid crystal panel 2 (that is, the luminance of illumination light from the light-emitting areas (4), (12), (20), (28), (5), (13), (21), and (29)). As a result, as shown in the curve 86 of FIG. 17(c), the luminance distribution of light outputted from the liquid crystal display device 1 as a whole is adjusted so as to be substantially even due to the luminance distribution of the liquid crystal panel 2 alone and the luminance distribution of the backlight device 3 offsetting each other.

With the above-mentioned configuration, in the present embodiment, functions and effects similar to those in Embodiment 4 above can be achieved. Also, in the present embodiment, in the backlight device 3 (backlight unit), the luminance of the light from the plurality of light-emitting areas (1) to (32) is changed on the basis of the gradation values in the liquid crystal panel 2 (display unit). As a result, in the present embodiment, the luminance of the light from the respective light-emitting areas (1) to (32) is changed on the basis of the gradation values in the display unit, and thus, even if the liquid crystal panel 2 is made large, it is possible to have a liquid crystal display device 1 with further improved display quality.

In the description above, a case was described in which, in the LED drive controller 38, it is determined whether low gradation display or high gradation display is being performed in the liquid crystal panel 2 on the basis of the first and second prescribed values, and the illumination of the light-emitting diodes 4 is changed based on this. However, the LED drive controller 38 of the present embodiment is not limited thereto, and a configuration may be adopted in which one prescribed value is used to determine whether low gradation display or high gradation display is being performed in the liquid crystal panel 2 to change the illumination of the light-emitting diodes 4, or in which three or more prescribed values are used to have four or more gradation degrees in the liquid crystal panel 2 and determining which gradation degree display is being performed to change the illumination of the light-emitting diodes.

All of the above-mentioned embodiments are illustrative and not limiting. The technical scope of the present invention is defined by the claims, and any modifications within a scope that corresponds to the configuration stated in the claims and their equivalents are also encompassed by the present invention.

For example, in the description above, a case was described in which the present invention is applied to a transmissive liquid crystal display device, but the display device of the present invention is not limited thereto, and the present invention can be applied to various types of display devices such as transflective liquid crystal display devices, or projection display devices using a light bulb on a liquid crystal panel.

Also, in the description above, light-emitting diodes were used as the light source, but the light source of the present invention is not limited thereto, and discharge tubes such as cold cathode fluorescent lamps or hot cathode fluorescent lamps can be used, for example.

Besides what was described above, the present invention may be applied to a normally white mode liquid crystal panel.

Also, besides what was described above, Embodiments 1 to 5 may be combined as appropriate.

### INDUSTRIAL APPLICABILITY

The present invention is useful for a display device in which it is possible to improve display quality even when the display unit is made large.

### DESCRIPTION OF REFERENCE CHARACTERS

1 liquid crystal display device
2 liquid crystal panel (display unit)
3 backlight device (backlight unit)
4 light-emitting diode (light source)
6 light guide plate
6b light-emitting surface
8 reflective sheet (reflective unit)
11 prism sheet
P pixel
A1 to A32 display area
(1) to (32) light-emitting area

1. A display device, comprising:
a backlight unit having a light source;
a display unit that includes a plurality of pixels and that displays information using illumination light from the backlight unit; and
a controller that performs drive control of at least the display unit using an inputted image signal,
wherein the backlight unit emits illumination light towards the display unit, the illumination light being adjusted to have an uneven luminance distribution across a plane parallel to the display unit in order to offset uneven characteristics in the display unit so that a luminance distribution of light outputted from the display unit is substantially even across the display unit.

2. The display device according to claim 1,
wherein the backlight unit is provided with a light guide plate that guides light from the light source in a prescribed direction so as to output the light towards the display unit, and
wherein the light guide plate has a plurality of portions that respectively output light at different luminances such that the illumination light has said uneven luminance distribution.

3. The display device according to claim 1,
wherein the backlight unit is provided with a reflective unit that reflects light from the light source back towards the display unit, and
wherein the reflective unit has a plurality of portions respectively having different reflectances such that the illumination light has said uneven luminance distribution.

4. The display device according to claim 1,
wherein the backlight unit is provided with a prism sheet that collects illumination light traveling to the display unit, and
wherein the prism sheet has a plurality of portions respectively having different degrees of light collection such that the illumination light has said uneven luminance distribution.

5. The display device according to claim 1,
wherein a plurality of display areas are defined within the display unit,
wherein the backlight unit has a plurality of light-emitting areas that radiate light from the light source to the plurality of display areas, respectively,
wherein the controller is configured so as to perform drive control of the display unit and the backlight unit based on an inputted image signal, and
wherein the controller controls the backlight such that luminances of light emitted from at least some of the plurality of light-emitting areas are different from each other such that the illumination light has said uneven luminance distribution.

6. The display device according to claim 5, wherein, in the backlight unit, the luminances of the light from the plurality of light-emitting areas are changed based on gradation values in the display unit.

7. The display device according to claim 1, wherein the display unit is a liquid crystal panel.
